(19) United States
(12) Patent Application Publication
(10) Pub. No.: US 2004/0058215 A1
(43) Pub. Date: Mar. 25, 2004

(54) Fuel cell system for mobile applications with latent heat storage, and method for thermally insulating the fuel cell system

(76) Inventors: Rolf Bruck, Bergisch Gladbach (DE); Joachim Grosse, Erlangen (DE); Manfred Poppinger, Uttenreuth (DE); Meike Reizig, Bad Munstereifel (DE)

Correspondence Address: Lerner and Greenberg, P.A., P.O. Box 2480, Hollywood, FL, 33022-2480, US

(21) Appl. No.: 10/609,807

(22) Filed: Jun. 30, 2003

Related U.S. Application Data
(63) Continuation of application No. PCT/DE01/04885, filed on Dec. 21, 2001.

(30) Foreign Application Priority Data
Dec. 29, 2000 (DE) 100 65 304.9

(51) Int. Cl. H01M 8/12; H01M 8/04

(52) U.S. Cl. 429/32; 429/26; 429/24; 429/13

(57) ABSTRACT

A smooth operation with different boundary conditions is required in order for fuel cell systems to be practically used in motor vehicles. To this end, the operating temperature of the fuel cell unit is equalized under varying load conditions. This is effected by a latent heat storage that is located upstream from the fuel cell unit in the vehicle, that is, the latent heat storage device extracts energy from or supplies energy to the fuel cell module as needed.

### CROSS-REFERENCE TO RELATED APPLICATION

This application is a continuation of copending International Application No. PCT/DE01/04885, filed Dec. 21, 2001, which designated the United States and which was not published in English.

### BACKGROUND OF THE INVENTION

1. Field of the Invention

The invention relates to a fuel cell system which is intended for mobile applications and which is provided with a latent heat storage. The invention also relates to an associated operating method, in particular to a method for thermally insulating the fuel cell system.

Numerous designs of fuel cell systems for supplying energy to electric motor drives of motor vehicles are known. A common feature of these different fuel cell systems is the chemical reaction of hydrogen with oxygen to form water. However, gaseous hydrogen cannot be stored on board in a quantity which is sufficient for prolonged driving operation. PEM fuel cells (Polymer Electrolyte Membrane, Proton Exchange Membrane), which operate with a proton-conducting membrane, operate on gasoline, methanol or other higher hydrocarbons as fuel, from which a hydrogen-rich fuel gas is obtained by way of a reformer, and with oxygen from the ambient air. In particular the HT-PEM fuel cell (HT, high temperature), which is operated at higher temperatures, is per se insensitive to impurities, which is true in particular of the fuel gas. The oxidizing agent is obtained from the ambient air, the starting point in principle being normal ambient air which, for example in a moving vehicle, can be removed from the air stream (see, for example, our copending application [GR 00 P 20293], published as WO 02/053402.

A problem with using fuel cell systems as an energy source for vehicles that are driven by an electric motor is the operation under different boundary conditions. After a cold start, full-load operation and/or operation under varying load conditions is to be possible as quickly as possible.

Japanese patent application JP 08-150506 A describes a fuel cell system and an operating method in which the fuel cell module is assigned a signal recording and control system which processes temperature values for the fuel cell stack, on the one hand, and the process gas supply, on the other hand, and emits control signals in this context for the operation of cooling and heating devices.

By contrast, Japanese patent document JP 60-270915 describes a fuel cell which is completely fitted into a thermal insulation that serves as a heat buffer.

Further reference is had to additional publications—all published after the claimed priority date of this application—namely, European patent applications EP 1 158 036 A1 and EP 1 081 779 A1, international PCT application WO 01/48848 A, and German patent application DE 199 30 875 A. These later-published documents propose measures and means which are used to thermally insulate fuel cells, in particular including PEM and HT-PEM fuel cells.

### SUMMARY OF THE INVENTION

It is accordingly an object of the invention to provide a fuel cell system for mobile applications and heat insulation method for the system which overcome the disadvantages of the heretofore-known devices and methods of this general type and which provide a system and a method with improved heat balance of the fuel cells.

With the foregoing and other objects in view there is provided, in accordance with the invention, a fuel cell system for mobile applications, comprising:

at least one fuel cell module containing PEM fuel cells operating at a given operating temperature;

thermal insulation substantially completely insulating the fuel cell module; and

a latent heat storage device communicating with the fuel cell module for supplying energy to or removing energy from the fuel cell module during mobile applications, for maintaining the given operating temperature in the mobile applications under different load conditions.

In the fuel cell system according to the invention, the operating temperature of the fuel cell modules is made more uniform even under varying load conditions. In particular when the fuel cell system is used as a powerplant to drive the motor in a motor vehicle, the specific thermal insulation compensates for undesirable temperature fluctuations which may adversely affect the efficiency of the system.

In the method according to the invention for operating the fuel cell system, a latent heat storage is connected upstream of the fuel cell module in the vehicle. In dynamic driving mode, the latent heat storage supplies or removes energy. For this purpose, in detail, process gases or a cooling medium is/are passed through the latent heat storage.

In the invention, the latent heat storage can be combined with other existing units. In particular, the heat store may form a structural unit with an air filter or with other heat exchangers. However, the latent heat storage may also already be part of the fuel cell module, which is designed as what is known as a stack.

In the context of the invention, the system is particularly advantageous if the fuel cell module includes PEM or HT-PEM fuel cells. In a specific embodiment, the PEM fuel cells are HT-PEM fuel cells and the given operating temperature is defined within a range from 120° C to 200° C.

In accordance with an added feature of the invention, an air filter is combined with the latent heat storage device. In addition, the latent heat storage device may be combined with a heat exchanger.

In accordance with a preferred embodiment of the invention, the latent heat storage device and the fuel cell module together form an integrated unit.

In accordance with an additional feature of the invention, the fuel cell system is configured in a power plant of a motor vehicle (i.e., as a drive for an electric motor of a motor vehicle), and the latent heat storage device is configured to substantially equalize the operating temperature during dynamic driving operation of the motor vehicle.

With the above and other objects in view there is also provided, in accordance with the invention, a method for thermally insulating a fuel cell system as outlined above in a motor vehicle. The method comprises:

equalizing an operating temperature of the fuel cell module of the fuel cell system to uniformity under varying load conditions of the motor; and

maintaining the thermal insulation even during operation of the fuel cell module to drive the motor vehicle.

In accordance with another feature of the invention, peaks of temperature fluctuations in mobile applications are buffered out.

In accordance with a further feature of the invention, the fuel cell module is heated to operating temperature with stored excess energy. In a preferred embodiment, one or more of the process gases are passed through the latent heat storage device.

In accordance with a concomitant feature of the invention, a cooling medium is passed through the latent heat storage device.

Other features which are considered as characteristic for the invention are set forth in the appended claims.

Although the invention is illustrated and described herein as embodied in a fuel cell system which is provided for mobile applications and which has a latent heat storage, and method for thermally insulating the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic side view of a motor vehicle with an integrated fuel cell system; and

FIG. 2 is a diagrammatic section through a fuel cell module with a latent heat storage device.

### DESCRIPTION OF THE PREFERRED EMBODIMENTS

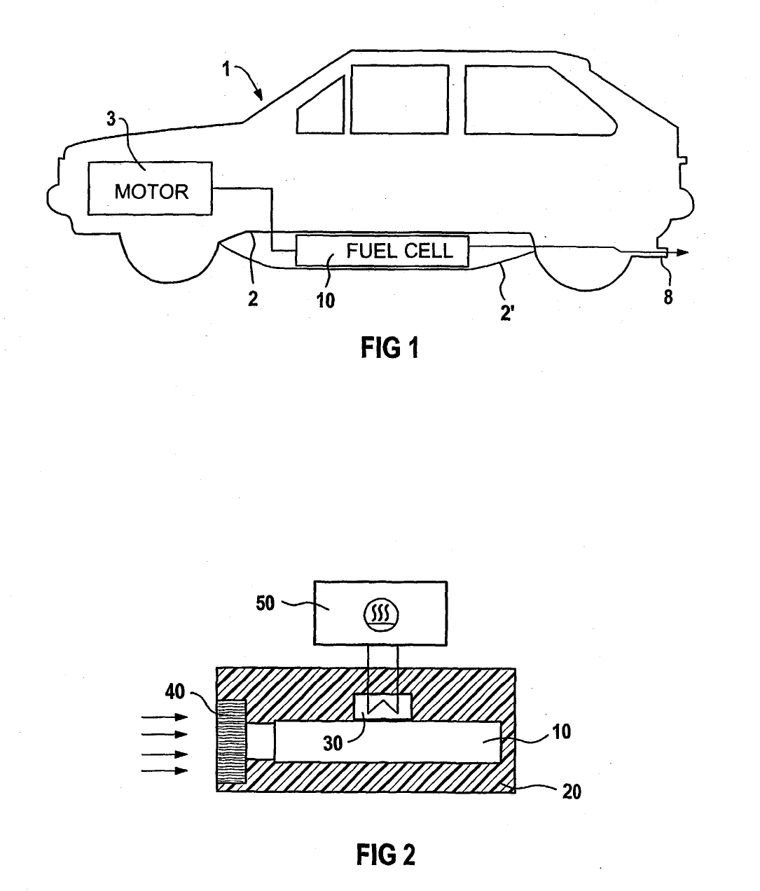

Referring now to the figures of the drawing in detail and first, particularly, to FIG. 1 thereof, there is shown a motor vehicle 1. An electric motor drive 3 of the vehicle 1 is supplied by a conventional fuel cell system. The fuel cell system substantially comprises a fuel cell module 10 and suitable auxiliary equipment. Details of the fuel cell system and its auxiliary equipment are not illustrated for reasons of clarity. At least the fuel cell module 10 has to be positioned in such a way at or in the vehicle that it is supplied with air in a suitable way. An airstream that is formed when the vehicle is moving can advantageously be used for this purpose.

Fuel cells which operate with a solid electrolyte and are known as PEM (Polymer Electrolyte Membrane or Proton Exchange Membrane) fuel cells are used for the fuel cell system. Fuel cells of this type are known from the prior art, fuel cells of this type for mobile applications advantageously being operated at higher temperatures than have previously been described.

Operating temperatures in the range 80° C. and 300° C., in particular at normal pressure in the range 120° C. to 200° C., are used for HT (High- Temperature) PEM fuel cells of this type.

For practical operation, in particular the fact that the moisture content of the process gases, on the one hand, and of the membrane, on the other hand, are independent of one another is advantageous. In this case, temperature-stable materials which accommodate a self-dissociating and/or autoprotolytic electrolyte are used as the membrane. Furthermore, in HT-PEM fuel cells, lower demands are imposed on the purity of the process gas than is the case for LT (Low-Temperature) PEM fuel cells, which have operating temperatures of below 100° C., in particular approximately 60° C. In particular, CO impurities in the process gas of up to 10,000 ppm can be tolerated.

A fuel cell module 10 with HT-PEM fuel cells may be of flat design. Specifically, a large number of fuel cells are stacked, so that in this case it is possible to refer to a flat stack. A flat stack of this type, also known just as stack for short, is advantageously arranged beneath the vehicle floor 2 in a free space formed with an underbody 2′ or—if it is not a passenger car but rather a truck or bus—may advantageously also be arranged on the roof of the vehicle. This ensures that the airstream reaches the fuel cells in a suitable way.

FIG. 2 illustrates a fuel cell module 10 of this type which comprises individual PEM fuel cells which together form what is known as the flat stack. Hydrogen or hydrogen-rich gas as burning gas, which is generated as fuel in a reformer from a liquid fuel, such as for example gasoline or methanol, by reforming on board the motor vehicle 1, and also ambient air as oxidizing agent are fed to a stack of this type.

To even out the operating temperature of the flat stack under varying load conditions, in FIG. 2 a latent heat reservoir or latent heat storage device 50 is assigned to or connected in parallel with the fuel cell module 10. The latent heat storage device 50, when the motor vehicle is operated in dynamic driving mode, supplies or removes energy (heat content Q) to or from the fuel cell module 10. For this purpose, one or more of the process gases are passed through the latent heat storage device 50. It is also possible for the cooling medium to be passed through the latent heat storage device 50.

For the latter purpose, the fuel cell module 20 is embedded in a large-volume thermal barrier coating 20, so that thermal insulation is ensured. Also, the thermal barrier coating 20 surrounds an air filter 40 connected upstream of the fuel cell module 10, resulting in a compact unit being formed with the fuel cell module 20. The latent heat storage device 50 is thermally coupled to the thermally insulated fuel cell module 10 via a heat exchanger 30.

If there is an air filter or a heat exchanger in the fuel cell system, the latent heat storage device 50 can be integrated with it. However, it is also possible for the latent heat storage device 50 to form a direct part of the fuel cell module 20. In this case, it is recommended to completely insulate all the fuel cell modules, so that the required operating temperature is maintained in a simple way even when the vehicle operating conditions fluctuate.

It has been found that the structure which has been described with reference to FIG. 2 makes it possible to improve the efficiency of fuel cell systems used as energy sources. This is of practical significance in particular when a PEM or HT-PEM fuel cell system is being used.

We claim:

1. A fuel cell system for mobile applications, comprising:
at least one fuel cell module containing PEM fuel cells operating at a given operating temperature;
thermal insulation substantially completely insulating said fuel cell module; and
a latent heat storage device communicating with said fuel cell module for supplying energy to or removing energy from said fuel cell module during mobile applications, for maintaining the given operating temperature in the mobile applications under different load conditions.

2. The fuel cell system according to claim 1, wherein said PEM fuel cells are HT-PEM fuel cells and the given operating temperature is defined within a range from 120° C. to 200° C.

3. The fuel cell system according to claim 1, which comprises an air filter combined with said latent heat storage device.

4. The fuel cell system according to claim 1, wherein said latent heat storage device is combined with a heat exchanger.

5. The fuel cell system according to claim 1, wherein said latent heat storage device and said fuel cell module together form an integrated unit.

6. The fuel cell system according to claim 1 configured in a power plant of a motor vehicle, wherein said latent heat storage device is configured to substantially equalize the operating temperature during dynamic driving operation of the motor vehicle.

7. A method for thermally insulating a fuel cell system, which comprises:
providing the fuel cell system according to claim 1 as a power plant for driving a motor of a motor vehicle;
equalizing an operating temperature of the fuel cell module of said fuel cell system to uniformity under varying load conditions of the motor; and
maintaining the thermal insulation even during operation of the fuel cell module to drive the motor vehicle.

8. The method according to claim 7, which comprises buffering out peaks of temperature fluctuations in mobile applications.

9. The method according to claim 7, which comprises heating the fuel cell module to operating temperature with stored excess energy.

10. The method according to claim 7, which comprises passing one or more process gases through the latent heat storage device.

11. The method according to claim 7, which comprises passing a cooling medium through the latent heat storage device.
